(19) United States
(12) Patent Application Publication
(10) Pub. No.: US 2019/0026753 A1
(43) Pub. Date: Jan. 24, 2019

(54) SYSTEMS AND METHODS FOR CHIP-EMBEDDED PRODUCT SEALS

(71) Applicant: Walmart Apollo, LLC, Bentonville, AR (US)

(72) Inventors: Richard Andrew White, Pineville, MO (US); Prasanth Pendam, Bentonville, AR (US); Sean Beebe, Noel, MO (US)

(21) Appl. No.: 16/040,681

(22) Filed: Jul. 20, 2018

Related U.S. Application Data
(60) Provisional application No. 62/535,712, filed on Jul. 21, 2017.

(51) Int. Cl. G06Q 30/00; G06K 7/10

(52) U.S. Cl. CPC G06Q 30/0185; G06K 7/10297; G06K 7/10366

(57) ABSTRACT

Exemplary embodiments for detecting product tampering include a processor in communication with a reader. A communication device, including a memory, an electronic circuit, and an antenna coupled to the electronic circuit, is coupled to a seal on product packaging. The electronic circuit is on a first portion of the seal and the antenna is on a second portion of the seal. The reader is configured to scan for a signal from the communication device. The processor is configured to detect tampering with the seal based on a lack of signal to the reader from the communication device. Tampering with the seal causes the antenna to disconnect from the electronic circuit rendering the communication device unreadable by the reader. The communication device is configured to write data in response to the antenna being disconnected from the electronic circuit. The processor is configured to read the tampering data in the memory.

### RELATED APPLICATION

This application claims priority to U.S. Provisional Application No. 62/535,712 filed on Jul. 21, 2017, the contents of which is hereby incorporated by reference in its entirety.

### BACKGROUND

Many products are sealed and protected. Sealing techniques include induction safety sealing, security tape, tax seals, warranty seals and tags, etc. Product packaging generally requires a visual inspection of the seal in order to verify that the seal has not been broken or tampered with. However, in some instances, visual inspection of a seal may not be possible or practical.

### SUMMARY

In one embodiment, a system for detecting product tampering is provided. The system includes a reader and a processor in communication with the reader. The reader is configured to scan for a signal from a communication device. The communication device includes a memory, an integrated circuit, and an antenna coupled to the integrated circuit. The communication device is configured to be operatively coupled to a seal on product packaging such that the antenna of the communication device is on a first portion of the seal and the integrated circuit of the communication device is on a second portion of the seal. The processor is configured to detect tampering with the seal on the product packaging based on a lack of the signal to the reader from the communication device. Tampering with the seal causes the antenna to disconnect from the integrated circuit rendering the communication device unreadable by the reader. The communication device is further configured to write tampering data to the memory in response to the antenna being disconnected from the integrated circuit. The tampering data indicates at least a timestamp corresponding to a time at which the antenna was disconnected from the integrated circuit. The processor is configured to read the data in the memory of the communication device when tampering with the seal is detected.

In accordance with embodiments of the present disclosure, a method for detecting product tampering is provided and a non-transitory computer readable medium is also provided that stores instructions that when executed causes a processor to implement the method. The method includes using a reader and scanning for a signal from a communication device operatively coupled to a seal on product packaging. The communication device includes a memory, an integrated circuit, and an antenna coupled to the integrated circuit. The communication device is coupled to the seal such that the antenna of the communication device is on a first portion of the seal and the integrated circuit of the communication device is on a second portion of the seal. The method also includes detecting, at a processor, tampering with the seal on the product packaging based on a lack of signal to the reader from the communication device. Tampering with the seal causes the antenna to disconnect from the integrated circuit rendering the communication device unreadable by the reader. The method further includes reading, at the processor, tampering data from the communication device when tampering with the seal is detected. The tampering data is written to the memory of the communication device by the integrated circuit when the antenna is disconnected from the integrated circuit. The tampering data indicates at least a timestamp for when the antenna was disconnected from the integrated circuit.

### BRIEF DESCRIPTION OF THE DRAWINGS

The accompanying drawings, which are incorporated in and constitute a part of this specification, illustrate one or more embodiments of the present disclosure and, together with the description, help to explain embodiments of the present disclosure. The embodiments are illustrated by way of example and should not be construed to limit the present disclosure. In the drawings:

FIG. 1A is a block diagram of an exemplary detection system for chip-embedded product seals, according to an example embodiment;

FIG. 1B is a block diagram of an exemplary seal for product packaging, according to an example embodiment;

FIG. 1C is a block diagram of an exemplary seal for product packaging that has been tampered with, according to an example embodiment;

FIG. 1D is block diagram of an exemplary reader, according to an example embodiment;

FIG. 2 is a block diagram showing an exemplary detection system in terms of modules, according to an example embodiment;

FIG. 3 is a flowchart illustrating an exemplary method for detecting product tampering, according to an example embodiment;

FIG. 4A is a schematic of an exemplary chip-embedded seal on product packaging, according to an example embodiment;

FIG. 4B is a schematic of an exemplary chip-embedded seal on product packaging, according to an example embodiment;

FIG. 5 is a diagram of an exemplary network environment suitable for a distributed implementation of exemplary embodiments; and

FIG. 6 is a block diagram of an exemplary computing device that may be used to implement exemplary embodiments described herein.

### DETAILED DESCRIPTION

Business entities that manufacture and/or sell products need to ensure that product packaging or seals are not compromised or damaged before the product is sold to a customer. A compromised seal can be an indicator that the seal has been tampered with or that the seal has failed or is otherwise damaged. Business entities also need mechanisms to monitor and track product packaging and inventory. Exemplary embodiments provide systems and methods for chip-embedded product seals. Using the chip-embedded product seal, a detection system described herein is capable of detecting that a product seal has been comprised, which can be an indicator of product tampering.

In exemplary embodiments, product packaging includes a seal embedded with a communication device. The communication device is operatively coupled to the seal such that an antenna of the communication device is on one portion of the seal, while an electronic circuit of the communication device is on another portion of the seal. When the seal is compromised, tampered with or damaged, the antenna is disconnected from the electronic circuit, rendering the communication device unreadable by readers or scanners.

The detection system described herein detects tampering with the seal on product packaging based on a lack of signal to the reader from the communication device. For example, the reader may transmit a first signal and wait for a response signal from the communication device. A lack of a response signal from the communication device can be an indication that the seal has been compromised. In an example embodiment, the communication device is configured to write tampering data to the memory of the communication device, where tampering data indicates a time at which the antenna is disconnected from the electronic circuit.

The systems and methods described herein may replace or enhance existing product sealing systems and methods. Embedding a communication device into product seals removes the dependency on visual examination of product packaging to realize changes to physical properties of the product seals. In some embodiments, the communication device can incorporated in or on the seal such that the device or antenna is destroyed or damaged when the seal is breached. A reader can detect the presence of an active communication device or lack of a functional/operational communication device. In this manner, inspection of product packaging for tampering or damage can be automated. In some embodiments, the communication device is not irreparably damaged or destroyed when the seal is broken, and upon detection of a compromised seal (e.g., based on a lack of a functional/operational communication device), the communication device can be repaired (e.g., by reconnecting the antenna to the integrated circuit) to facilitate reading the tampering data written to the memory of the communication device when the seal was compromised.

The contents of the communication device may be protected via various security methods, including intent filters. The intent filter only allows certified devices to write data to and read data from the communication device.

The detection system and chip-embedded product seals described herein provide many benefits in terms of inventory management and detecting a compromised product seal, which can be indicative of product tampering, damage or a seal failure. Some of the benefits include product leakage prevention, pilferage protection, sustainability, production speed, early product tampering detection, early resolution of inventory issues, information on product tampering, information on tracking inventory, and others.

In an example embodiment, the chip-embedded product seal can be used to detect that the seal has been compromised potentially indicating product tampering or a failure of the seal. In the event that the seal is compromised (e.g., as a result of tampering), the ability for the communication device in the product seal to receive or transmit signals is disabled. When the product packaging having a compromised seal is scanned by the reader, the communication device operatively coupled to the seal is non-responsive. Such scanning can be performed in an automated manner, and may be performed at the time of purchase or during any point of the inventory management process.

In another embodiment, the chip-embedded product seal can be used to detect that the seal has been compromised potentially indicating leakage of product packaging (e.g., a failure of the seal). The product packaging, which may be a container, can sealed using induction sealing. The communication device is incorporated in the induction sealing, such that the antenna is in one layer of the sealing and the electronic circuitry is in another layer of the sealing. The antenna and the electronic circuitry remain connected when the packaging is under positive pressure (e.g., as caused by inert gas packaging) or under negative pressure (e.g., as caused by vacuum packaging). If the pressure within the packaging changes, the antenna can be disconnected from the electronic circuitry, disabling the ability of the communication device to receive or transmit signals.

In another embodiment, pilferage identification can be enhanced through monitoring the communication devices in the product packaging seals. The communication device contains quantified values and sum of those values audited. The communication device is associated with a unique identifier, and stores the date and time of the last scan of the communication device. If a particular product packaging is not found during an audit or inventory scan, a cross reference of inventory records and last scan date and time can help identify a timeframe when the product packaging was lost. The timeframe may be determined as being between the audit time and the last scan time.

In another embodiment, enhanced sustainability and freshness can be obtained by comparing scanned communication devices to previous audit data to detect, identify and remove breached or damaged products from undamaged or unaffected products. In the example of produce, one spoiled piece of produce in a product packaging or container containing multiple pieces can spoil the other pieces of produce. The detection system described herein enables personnel to identify packaging containing spoiled produce, so that it can be removed as soon as possible. The ability to identify the spoiled produce sooner than a visual inspection reduces the amount of time that good produce is exposed to spoiled produce, and also reduces waste of product due to spoilage.

In another embodiment, production speed can be increased as the functions of tracking, measuring, monitoring and reporting can be automated using the chip-embedded seals, removing the need for manual visual inspection of product.

Also, shipping costs are reduced as the inventory of the shipped product can be audited from loading through delivery via an automated process. Product lost during shipping (because of damage, pilferage, spoilage, etc.) can be accounted for sooner (as compared to manual visual inspections), and remedied faster. Moreover, causes for lost product can be determined to prevent future losses.

The communication device may be a passive electronic device. Passive electronic devices require an electrical current to operate, but do not include an electrical power source within the device itself to produce electrical current. Energy or power within passive devices can be induced by an external source of energy to generate the current that they consume. In an example embodiment, the communication device described herein uses an ultra-high frequency radio wave transmitted by the reader as the external source of energy. Some examples of passive electronic devices that can form at least a portion of the communication device include passive RFID tags and/or passive near-field communication (NFC) chips.

The communication device is embedded in the seal, and includes electronic circuitry, an antenna and memory. The components of the communication device may be provided as an electronic chip. In some embodiments, the communication device is a Near Field Communication device or a Radio-frequency identification device. The communication device may be applied to the product packaging at time of bottling, stamping or closing of packaging.

In exemplary embodiments, the communication device may store data in the memory related to product recalls, including removal or corrections. When scanned, the data stored in the memory may be displayed at a display device to indicate to a user that there is a product recall for the item.

In another embodiment, guidelines for tax stamps may be stored in the communication device. In an example embodiment, warranty information may be stored in the communication device. The communication device may include data necessary to execute custom software.

As used herein, product packaging refers to packaging surrounding a product, packaging containing a product, or packaging enclosing a product. The packaging may be a box, a crate, a container, a bottle, a jar, a mesh bag (for example to package produce), a plastic bag, or other packaging.

As used herein, a seal for product packaging may be an adhesive tape, an adhesive seal, a warranty seal, a tax seal, a security seal, a stamp, a pull-tie (to secure a bag-type packaging), and other seals.

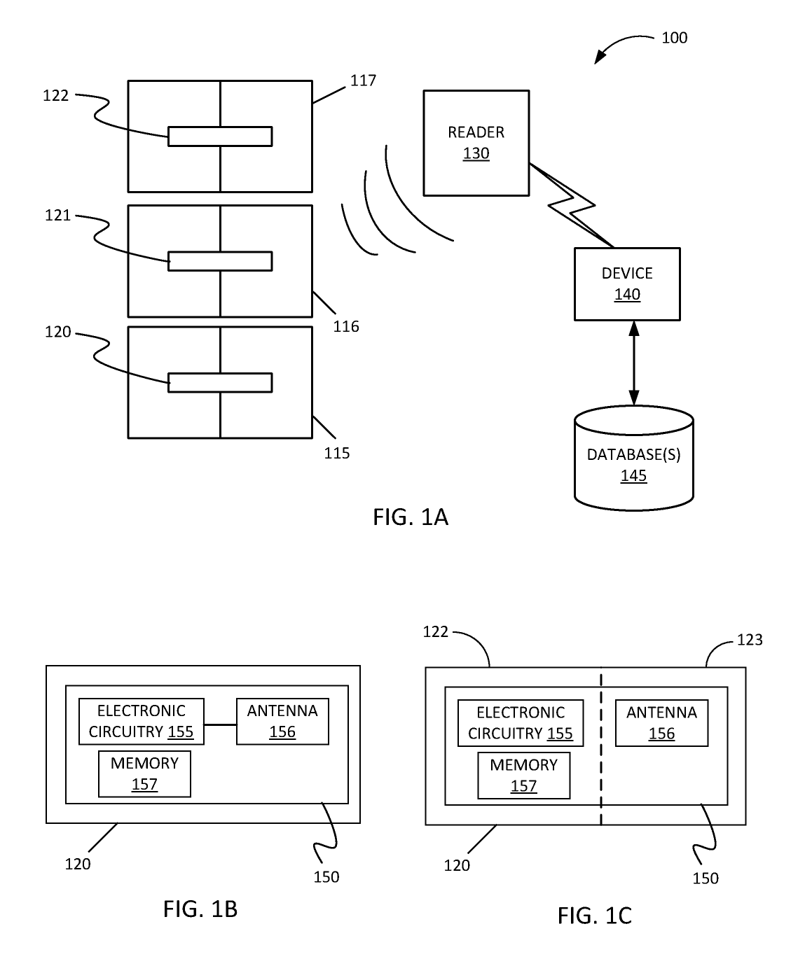

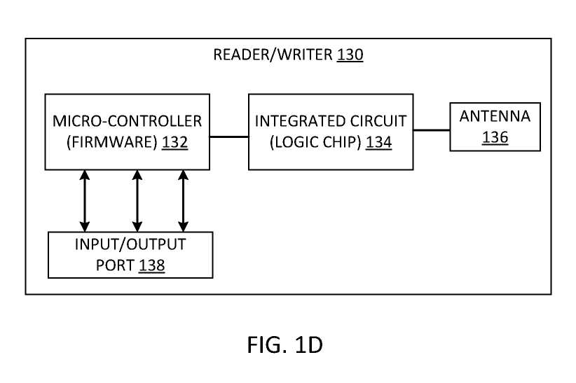

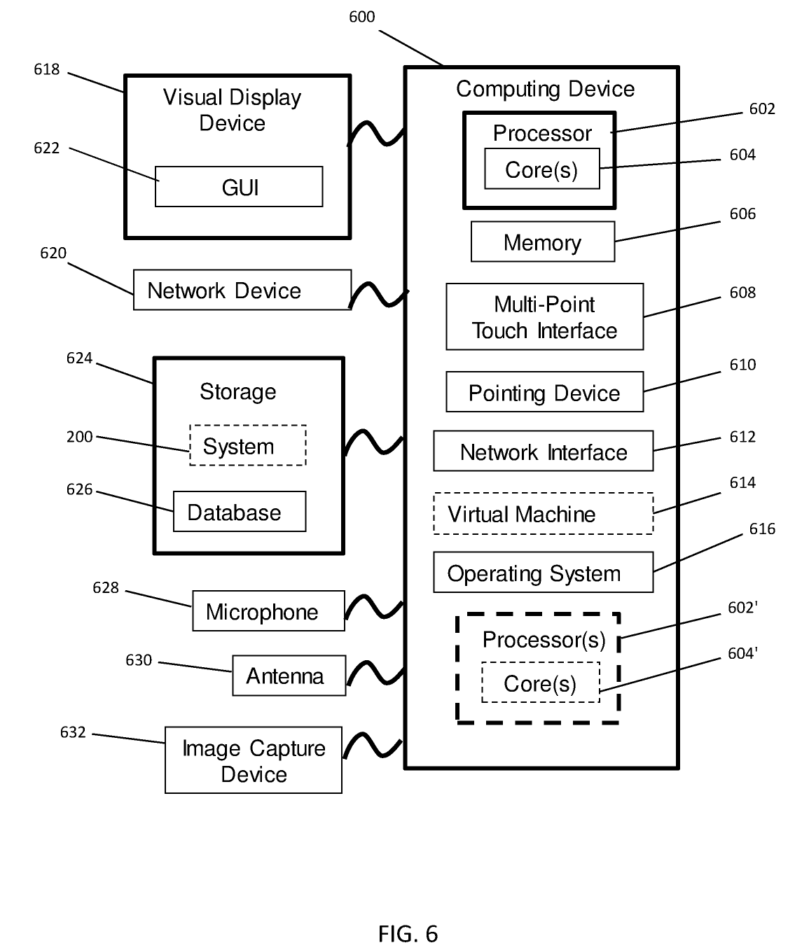

FIG. 1A is a block diagram of an exemplary detection system 100 for chip-embedded product seals, according to an example embodiment. The detection system includes a reader 130 (e.g., an RFID reader or an NFC reader), a device 140, and database(s) 145. The reader 130 is configured to scan chip-embedded seals on product packaging. For example, product packaging 115 is sealed with seal 120 that includes a corresponding communication device. Product packaging 116 is sealed with seal 121 that includes a corresponding communication device. Product packaging 117 is sealed with seal 122 that includes a corresponding communication device. The components of the communication device included in the seal on the product packaging are described further in relation with FIG. 1B and FIG. 1C. The components of the reader 130 are described further in relation with FIG. 1D. The device 140 is in communication with the reader 130 via a wireless or wired connection. The device 140 may include one or more components described in relation with FIG. 6. The device 140 includes a processor configured to detect that the seal on the product packaging has been compromised (e.g., as a result of product tampering or a failure of the seal) based on a lack of a response signal from the communication device to an interrogation signal from the reader 130.

FIG. 1B is a block diagram of an exemplary seal 120 for product packaging, according to an example embodiment. The seal 120 includes a communication device 150. In some embodiments, the communication device 150 is a Near-Field Communication (NFC) tag or device. In some embodiments, the communication device 150 is a Radio-frequency identification (RFID) tag or device. The communication device 150 includes electronic circuitry 155, an antenna 156, and memory 157. The electronic circuitry 155 is electrically coupled to the antenna 156. The antenna 156 may be a short-range antenna to facilitate communication with the reader 130. The reader 130 is configured to scan or read a signal from the antenna 156. The electronic circuitry 155 includes digital logic circuits, a controller, a transceiver, and memory storing software code executable by the digital logic circuits or controller to facilitate functionalities of the detection system 100. The memory 157 may store data including, but not limited to, an identifier number for the product packaging, product name, a source of the product, a manufacturer of the product, a lot number associated with the product, identifier number for the communication device, and other data identifying the product, the product packaging, and/or the communication device.

In some embodiments, the reader 130 is configured to read data in the memory 157 of the communication device 150 and write data to the memory 157 of the communication device 150. The reader 130 can read or write to the communication device 150 when it is within range of the reader 130. In some embodiments, the reader 130 transmits radio waves (i.e. electromagnetic radiation at radiofrequency) to the communication device 150, which can induce power in the electronic circuitry 155 sufficient to operate the communication device 150.

FIG. 1C is a block diagram of the exemplary seal 120 for product packaging that has a seal that has failed or has been tampered with, according to an example embodiment. As shown in FIG. 1B, the electric connection between the electronic circuitry 155 and antenna 156 is intact or undamaged. In contrast, as shown in FIG. 1C, the electronic circuitry 155 and antenna 156 are mechanically and electrically disconnected. As illustrated, the electronic circuitry 155 of the communication device 150 is on a first portion 122 of the seal 120, while the antenna 156 of the communication device 150 is on a second portion 123 of the seal 120. The seal 120 is applied to the product packaging (for example, product packaging 115) such that the first portion 122 of the seal 120 is on a first portion of the product packaging and the second portion 123 of the seal 120 is on a second portion of the product packaging. As such, the electronic circuitry 155 and the antenna 156 of the communication device 150 are on separate portions or sides of the seal 120 and the product packaging 115. If there is an attempt to access the contents in the product packaging and the seal 120 is tampered with, then the antenna 156 is disconnected from the electronic circuitry 155.

The communication device 150 is configured to write tampering data to the memory 157 in response to the antenna 156 being disconnected from the electronic circuitry 155. The tampering data indicates a timestamp corresponding to a time at which the antenna 156 is disconnected from the electronic circuitry 155. The tampering data may also indicate or include other data such as product recall information, tax information, warranty information, and other information related to the product. The processor of device 140 is configured to read the tampering data in the memory of the communication device when tampering with the seal is detected, or when a compromised or damaged seal is detected.

FIG. 1D is a block diagram of an exemplary reader 130. As shown in FIG. 1D, the reader 130 includes a micro-controller 132, an integrated circuit 134 (e.g., a logic chip), an antenna 136, and an input/output port 138. The input/output port 138 receives via the antenna 156 inputs, for example, data or signals from the communication device 150, and outputs via the antenna 156, for example, data or signals to the communication device 150. The input/output port 138 may also receive input from and provide output to the device 140. The microcontroller 132 includes one or more CPUs (processor cores) along with memory and programmable input/output peripherals, and digital circuitry to execute firmware that can provide a layer of security, such as data encryption and the like. The integrated circuit 134 includes digital logic circuitry or software code that enables the reader 130 to read data from and write data to the communication device 150. The antenna 136 is compatible with the antenna 156 of the communication device to enable the reader 130 to read a signal from the communication device 150. That is, the antenna 136 and the antenna 156 match in wave or signal frequency. The reader 130 may communicate with the communication device 150 via a specified frequency.

In an example embodiment, the antenna 156 is reconnected to the electronic circuitry 155 after the seal is compromised, damaged, or tampered with. After reconnection, the communication device 150 is scanned or read for a signal, and the data from the memory 157 of the communication device 150 is read to determine when the antenna 156 was disconnected from the electronic circuitry 155.

In an example embodiment, the reader 130 writes scan time data to the memory 157, where the scan time data indicates a timestamp corresponding to a time at which the communication device 150 was scanned or read by the reader 130. In another embodiment, the processor of the device 140 is configured to store scan time data and a device identifier number uniquely identifying the communication device in the database(s) 145. The scan time data indicates a time at which the communication device associated with the identifier number was scanned or read by the reader 130. Thus, the detection system is configured to create an inventory record of the product packaging and the time that the packaging is scanned. The inventory record in the database(s) 145 may include location information for each device identifier, where the location information indicates where the product packaging was located at the time of scan. The location information may be determined based on data inputted in device 140 at the time of scan, for example, personnel may enter information at the device 140 indicating the location of the scan. Alternatively, the location information may be determined based on sensors coupled to the product packaging. The communication device 150 may include a location sensor or GPS.

In an example embodiment, the processor of device 140 is configured to analyze the inventory record stored in the database(s) 145, including the scan time data and the unique device identifiers. The processor is configured to determine that a specific product packaging associated with a specific device identifier is missing at the time of analysis. The processor is configured to determine the amount of time the product packaging is missing based on the time of analysis and the last stored scan time data. An alert may be generated by the processor when the detection system determines that a product packaging is missing. In this manner, the detection system is able to aid in tracking of inventory, alert personnel when product packaging is missing, and provide information on when the product packaging was last scanned. The detection system may also provide location information to determine where the missing product packaging was last located.

In an example embodiment, a sensor is included on or in the product packaging and is in communication with the communication device 150. The sensor may be configured to sense quality or freshness of the product in the product packaging. The communication device 150 is configured to write the quality data sensed by the sensor in the memory 157 of the communication device 150. In some embodiments, the reader 130 is configured to read the quality data stored in the memory 157. The processor of the device 140 analyzes the quality data and determines whether the product is meets a quality or freshness threshold or criteria. If the quality data indicates that the product does not meet a quality threshold, then the processor is configured to generate an alert. The alert may be transmitted to another computing device to alert personnel that the product is of low quality and should not be displayed for sale.

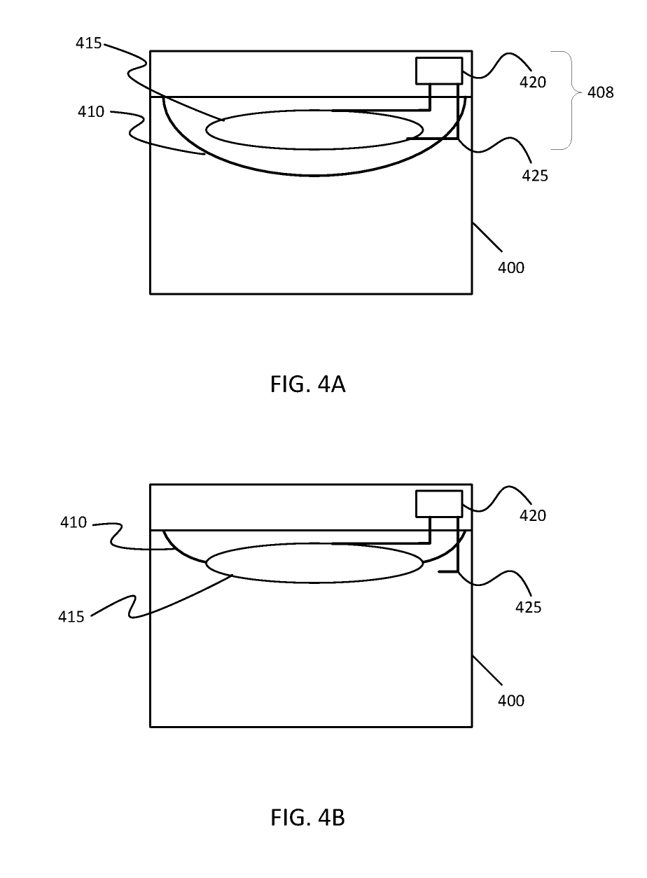

In an example embodiment, the product packaging is sealed under pressure. The communication device is embedded in the product packaging and seal such that the antenna of the communication device disconnects from the electronic circuitry when there is a change in the pressure in the product packaging. In this manner, the detection system can detect tampering with a pressurized seal, or a compromised or damaged pressurized seal. Exemplary product packaging sealed under pressure is further described in relation to FIGS. 4A and 4B.

An example embodiment includes a sorting mechanism configured to automatically sort items based on reading data in the memory of the communication device. The sorting mechanism may sort items based on detecting tampering with the seal, or detecting a compromised or damaged seal of the product packaging. The sorting mechanism may sort items based on the quality or freshness of the product.

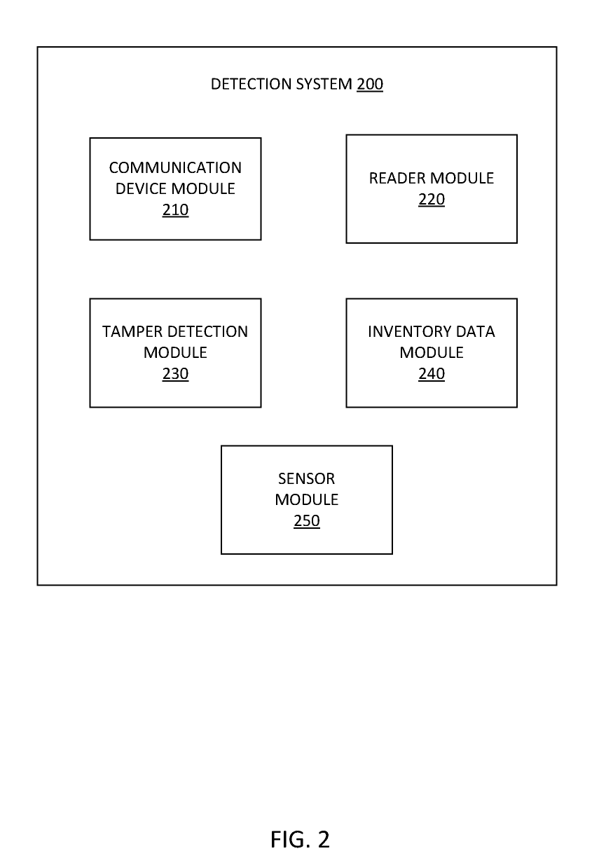

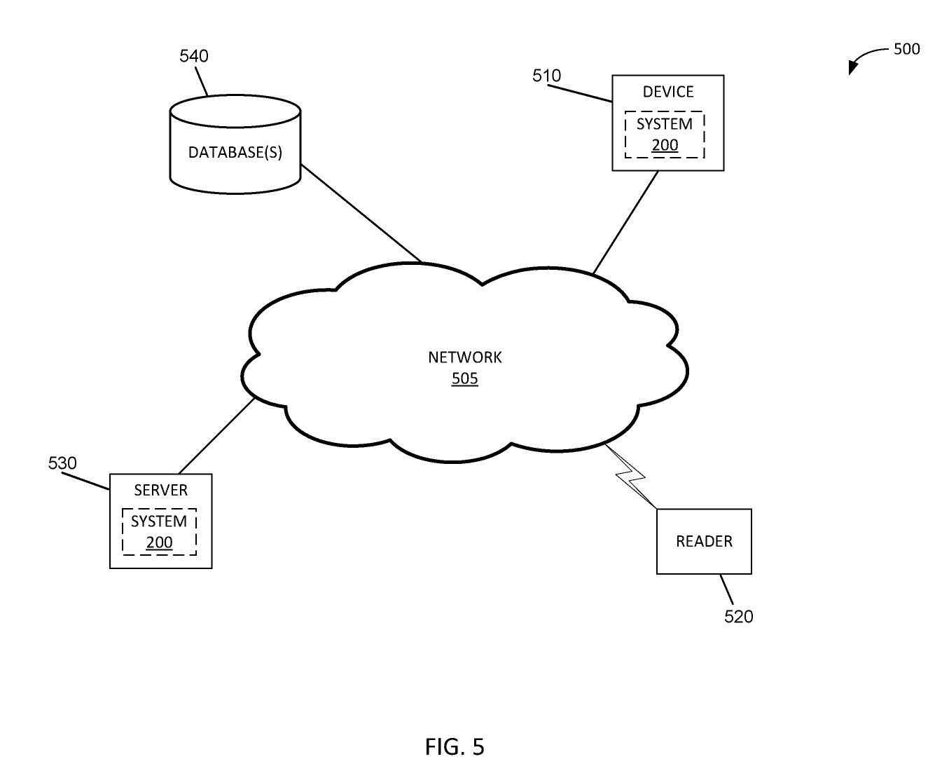

FIG. 2 is a block diagram showing a detection system 200 in terms of modules for detecting compromised product seals (tampering with or failure of a product seal), according to an example embodiment. The modules include a communication device module 210, a reader module 220, a tamper detection module 230, an inventory data module 240, and a sensor module 250. The modules may include various circuits, circuitry and one or more software components, programs, applications, or other units of code base or instructions configured to be executed by one or more processors (e.g., processors included in a device 510 or a server 530 shown in FIG. 5). In an example embodiment, one or more of modules 210, 220, 230, 240, 250 is included in a device (e.g., device 510 shown in FIG. 5). In another embodiment, one or more of the modules 210, 220, 230, 240, 250 may be included in a server (e.g., server 530 shown in FIG. 5). Although modules 210, 220, 230, 240, 250 are shown as distinct modules in FIG. 2, it should be understood that modules 210, 220, 230, 240, and 250 may be implemented as fewer or more modules than illustrated. It should be understood that one or more of modules 210, 220, 230, 240, and 250 may communicate with one or more components included in exemplary embodiments of the present disclosure (e.g., device 510, reader 520, server 530, or database(s) 540 of system 500 shown in FIG. 5).

The communication device module 210 may be a hardware-implemented module configured to manage and maintain data related to communication devices embedded in the product packaging seals. For example, the communication device module 210 may manage and maintain a list of communication devices embedded in seals and the corresponding product packaging information.

The reader module 220 may be a hardware-implemented module configured to manage and maintain data related to readers. For example, the reader module 220 may manage and maintain a list of readers and location of the readers. In some embodiments, the readers may be affixed to a particular location, for example, to a conveyor belt moving product packaging. In other embodiments, the readers may be a hand-held scanner or reader used by personnel to scan inventory. The reader module 220 may also be configured to read data from the memory of the communication device.

The tamper detection module 230 may be a hardware-implemented module configured to analyze signal and data read from the communication devices, and detect compromised or damaged seals, tampering with product packaging based on the signal and/or data read from the communication devices embedded in the seals.

The inventory data module 240 may be a hardware-implemented module configured to create and manage an inventory record based on scanning of product packaging seals by the reader of the detection system 100. The inventory data module 240 may also be configured to analyze inventory records and determine when product packaging is missing.

The sensor module 250 may be a hardware-implemented module configured to manage data sensed by various sensors coupled to the product packaging or the seal. The sensor module 250 may be configured to analyze sensed data to determine whether product meets quality or freshness criteria.

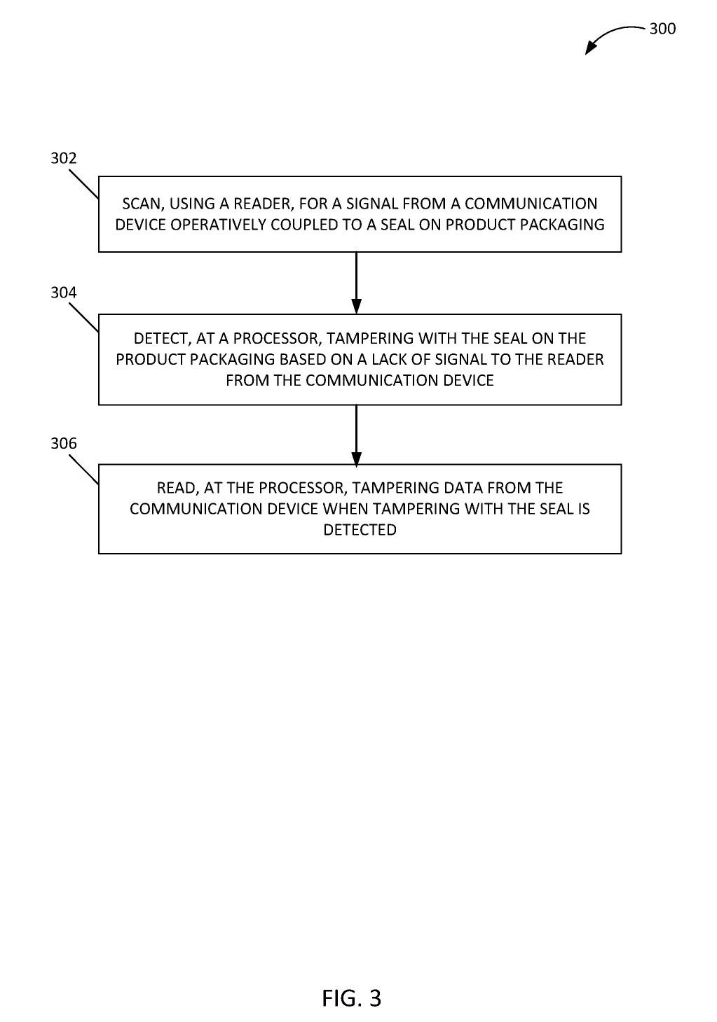

FIG. 3 is a flowchart illustrating an exemplary method 300 for detecting product tampering, according to an example embodiment. The method 300 may be performed using one or more modules of the detection system 200 described above.

At step 302, the reader 130 scans for a signal from the communication device 150 that is operatively coupled to the seal 120 on product packaging 115. As described above, the communication device 150 includes electronic circuitry 155, antenna 156 and memory 157. The antenna 156 is coupled to the electronic circuitry 155. The communication device 150 is coupled to the seal such that the antenna 156 is on a first portion of the seal 120 and the electronic circuitry 155 is on a second portion of the seal 120.

At step 304, the tamper detection module 230 detects tampering with the seal 120 or a compromised seal on the product packaging 115 based on a lack of signal to the reader 130 from the communication device 150. Tampering with or damaged to the seal 120 causes the antenna 156 to mechanically and electrically disconnect from the electronic circuitry 155, and renders the communication device 150 unreadable by the reader 130.

At step 306, the tamper detection module 230 reads tampering data from the communication device 150 when tampering with the seal or a compromised seal is detected. In an example embodiment, the method 300 includes reconnecting the antenna 156 to the electronic circuitry 155, and reading a signal from the communication device 150 and data from the memory 157. The tampering data is written to the memory 157 of the communication device 150 by the electronic circuitry 155 when the antenna 156 is disconnected from the electronic circuitry 155. The electronic circuit may include a capacitor that holds a reserve charge to power the device to write data upon detection that the antenna is disconnected. The tampering data includes at least a timestamp indicating a time when the antenna 156 is disconnected from the electronic circuitry 155.

In an example embodiment, the method 300 includes sensing quality of the product using a sensor coupled to the product packaging. The sensor can include, for example, a mass-spectrometer, an optical spectrometer, a color sensor, a gas sensor, a weight sensor, and other sensors that may detect quality of the product. The sensed quality data may be written to the memory 157 of the communication device 150. In some embodiments, the sensor module 250 reads the quality data in the memory 157, and determines if the product quality or freshness is below a threshold value. If the quality or freshness of the product is below the threshold, then an alert is generated by the detection system 200.

In an example embodiment, the inventory data module 240 stores scan time data and a unique device identifier in database(s) 145. The scan time data includes a timestamp indicating a time at which the communication device associated with the unique device identifier was scanned by the reader. The inventory data module 240 analyzes the scan time data and the unique device identifier stored in the database(s) 145, and determines that a particular product packaging associated with a particular unique device identifier is missing at the time of analysis. The inventory data module 240 determines an amount of time the particular packaging is missing based on the time of analysis and the stored scan time data.

FIG. 4A is a schematic of an exemplary chip-embedded seal on product packaging 400 under pressure, according to an example embodiment. FIG. 4A illustrates a seal that has not been tampered with or is otherwise undamaged. FIG. 4B is a schematic of an exemplary chip-embedded seal on product packaging 400 under pressure, according to an example embodiment. FIG. 4B illustrates a seal that has been tampered with and is damaged. The product packaging 400 is sealed using pressure. The seal 408 includes a diaphragm 410. A communication device is embedded in the seal 408. An antenna 415 of the communication device is coupled to a first portion of the seal 408, for example the diaphragm 410, while electronic circuitry 420 of the communication device is coupled to a second portion of the seal 408. The antenna 415 is operatively connected to the electronic circuitry 420.

When the packaging 400 is under vacuum as shown in FIG. 4A, the diaphragm 410 is inflated and effectively pulls the antenna 415 downward, and the antenna 415 remains mechanically and electrically connected to the electronic circuitry 420. Thus, the communication device is active and the reader 130 is able to read a signal from while the seal is under pressure (that is, undamaged). When there is a breach in the packaging 400, the seal 408 is no longer under vacuum and there is a change in pressure in the seal, as shown in FIG. 4B. When the seal is no longer under vacuum, the diaphragm 415 is deflated or collapsed, causing the antenna 415 to mechanically and electrically disconnect from the electronic circuitry 420. Thus, the communication device is rendered unreadable by the reader 130.

FIG. 5 illustrates a network diagram depicting a system 500 for implementing the detection system described herein, according to an example embodiment. The system 500 can include a network 505, a device 510, a reader 520, a server 530, and database(s) 540. Each of the device 510, reader 520, server 530, and database(s) 540 may be in communication with the network 505.

In an example embodiment, one or more portions of network 505 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The device 510 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. The device 510 can include one or more components described in relation to computing device 600 shown in FIG. 6. One or more components of the detection system 200 may be included on the device 510.

The reader 520 may be the same as the reader 130 described above. As described, the reader 520 is configured to scan or read a signal from the communication device embedded in the seal of product packaging. The reader 520 may be capable of reading data from the communication device and writing data to the communication device.

The device 510 may connect to network 505 via a wired or wireless connection. The device 510 may include one or more applications or systems such as, but not limited to, a web browser, an inventory management application, a product tamper detection system based on the detection system 200 described herein, and the like. In an example embodiment, the device 520 may perform some of the functionalities described herein.

Each of the database(s) 540 and server 530 is connected to the network 505 via a wired or wireless connection. The server 530 may include one or more computers or processors configured to communicate with the device 510 and/or reader 520 via network 505. The server 530 hosts one or more applications accessed by the device 510 and/or facilitates access to the content of database(s) 540. Database(s) 540 may include one or more storage devices for storing data and/or instructions (or code) for use by the server 530, and/or device 510. Database(s) 540 and server 530 may be located at one or more geographically distributed locations from each other or from device 510. Alternatively, database(s) 540 may be included within server 530. The server 530 may include one or more modules of system 200 described above. In an example embodiment, the server 530 may perform some of the functionalities described herein.

FIG. 6 is a block diagram of an exemplary computing device 600 that can be used to perform the methods provided by exemplary embodiments. The computing device 600 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer-readable and computer-executable instructions or software for implementing exemplary embodiments. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can include a computer system memory or random access memory, such as DRAM, SRAM, EDO RAM, and the like. Memory 606 can include other types of memory as well, or combinations thereof.

A user can interact with the computing device 600 through a visual display device 618, such as a touch screen display or computer monitor, which can display one or more user interfaces 619 that can be provided in accordance with exemplary embodiments. The visual display device 618 can also display other aspects, elements and/or information or data associated with exemplary embodiments. The computing device 600 can include other I/O devices for receiving input from a user, for example, a keyboard or other suitable multi-point touch interface 608, a pointing device 610 (e.g., a pen, stylus, mouse, or trackpad). The keyboard 608 and the pointing device 610 can be coupled to the visual display device 618. The computing device 600 can include other suitable conventional I/O peripherals.

The computing device 600 can also include one or more storage devices 624, such as a hard-drive, CD-ROM, or other computer readable media, for storing data and computer-readable instructions and/or software, such as the system 200 that implements exemplary embodiments of the detection system described herein, or portions thereof, which can be executed to generate user interface 619 on display 618. Exemplary storage device 624 can also store one or more databases for storing suitable information required to implement exemplary embodiments. The databases can be updated by a user or automatically at a suitable time to add, delete or update one or more items in the databases. Exemplary storage device 624 can store one or more databases 626 for storing data used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of the above. The network interface 612 can include a built-in network adapter, network interface card, PCMCIA network card, card bus network adapter, wireless network adapter, USB network adapter, modem or another device suitable for interfacing the computing device 600 to a type of network capable of communication and performing the operations described herein. Moreover, the computing device 600 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run operating systems 616, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or another operating system capable of running on the computing device and performing the operations described herein. In exemplary embodiments, the operating system 616 can be run in native mode or emulated mode. In an exemplary embodiment, the operating system 616 can be run on one or more cloud machine instances.

The following description is presented to enable a person skilled in the art to create and use a computer system configuration and related method and systems for detecting tampering with product seals or compromised product seals. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps can be replaced with a single element, component or step. Likewise, a single element, component or step can be replaced with multiple elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. A system for detecting product tampering, the system comprising:
a reader configured to scan for a signal from a communication device, the communication device having a memory, an electronic circuit and an antenna coupled to the electronic circuit, the communication device configured to be operatively coupled to a seal on product packaging such that the antenna of the communication device is on a first portion of the seal and the electronic circuit of the communication device is on a second portion of the seal; and
a processor in communication with the reader and configured to detect tampering with the seal on the product packaging based on a lack of the signal to the reader from the communication device, wherein tampering with the seal causes the antenna to disconnect from the electronic circuit rendering the communication device unreadable by the reader;
wherein the communication device is configured to write tampering data to the memory in response to the antenna being disconnected from the electronic circuit, the tampering data indicating at least a timestamp corresponding to a time at which the antenna was disconnected from the electronic circuit, and
wherein the processor is configured to read the data in the memory of the communication device when tampering with the seal is detected.

2. The system of claim 1, wherein after tampering with the seal is detected, the reader is configured to scan for a signal from the communication device after the antenna is reconnected to the electronic circuit.

3. The system of claim 1, further comprising a sensor for sensing quality of the product, and wherein the communication device is configured to write quality data sensed by the sensor in the memory of the communication device.

4. The system of claim 3, wherein the reader is configured to read the quality data in the memory of the communication device, and wherein the processor is configured to determine that the product quality is below a threshold value and generate an alert.

5. The system of claim 1, wherein the communication device is configured to write scan time data to the memory, the scan time data indicating a timestamp corresponding to a time at which the communication device was scanned by the reader.

6. The system of claim 1, wherein the processor is configured to store scan time data and a unique device identifier in a database, the scan time data indicating a timestamp corresponding to a time at which the communication device associated with the unique device identifier was scanned by the reader.

7. The system of claim 6, wherein the processor is configured to:
analyze the scan time data and the unique device identifier data stored in the database;
determine that a specific product packaging associated with a specific unique device identifier is missing at time of analysis, and
determine an amount of time the specific product packaging is missing based on the time of analysis and the stored scan time data.

8. The system of claim 1, wherein the product packaging is sealed under a pressure, and wherein the antenna of the communication device is configured to disconnect from the electronic circuit when a change in the pressure in the product packaging occurs.

9. The system of claim 1, further comprising a sorting mechanism configured to automatically sort a plurality of items based on reading data in the memory of the communication device coupled to the product packaging of each of the plurality of items.

10. The system of claim 9, wherein the sorting mechanism is configured to sort items based on detection of tampering with the seal of the product packaging.

11. The system of claim 1, wherein the communication device is a Near-Field-Communication tag or a RFID tag.

12. A method for detecting product tampering, the method comprising:
scanning, using a reader, for a signal from a communication device operatively coupled to a seal on product packaging, the communication device having a memory, an electronic circuit and an antenna coupled to the electronic circuit, and the communication device coupled to the seal such that the antenna of the communication device is on a first portion of the seal and the electronic circuit of the communication device is on a second portion of the seal;
detecting, at a processor, tampering with the seal on the product packaging based on a lack of the signal to the reader from the communication device, wherein tampering with the seal causes the antenna to disconnect from the electronic circuit rendering the communication device unreadable by the reader; and
reading, at the processor, tampering data from the communication device when tampering with the seal is detected, the tampering data being written to the memory of the communication device by the electronic circuit when the antenna is disconnected from the electronic circuit, the tampering data indicating at least a timestamp for when the antenna was disconnected from the electronic circuit.

13. The method of claim 12, further comprising:
reconnecting the antenna to the electronic circuit; and
reading a signal from the communication device and data in the memory of the communication device.

14. The method of claim 12, further comprising:
sensing quality of the product using a sensor coupled to the product packaging; and
writing the quality data in the memory of the communication device.

15. The method of claim 14, further comprising:
reading the quality data in the memory of the communication device;
determining that the product quality is below a threshold value; and
generating an alert.

16. The method of claim 12, further comprising:
storing scan time data and a unique device identifier in a database, the scan time data indicating a timestamp corresponding to a time at which the communication device associated with the unique device identifier was scanned by the reader.

17. The method of claim 16, further comprising:
analyzing the scan time data and the unique device identifier data stored in the database;
determining that a specific product packaging associated with a specific unique device identifier is missing at time of analysis, and
determining an amount of time the specific product packaging is missing based on the time of analysis and the stored scan time data.

18. The method of claim 12, wherein the product packaging is sealed under a pressure, and wherein the antenna of the communication device is configured to disconnect from the electronic circuit when a change in the pressure in the product packaging occurs.

19. The method of claim 12, further comprising:
sorting a plurality of items based on reading data in the memory of the communication device coupled to the product packaging of each of the plurality of items, wherein the sorting is based on detection of tampering with the seal of the product packaging.

20. A non-transitory machine readable medium storing instructions that when executed causes a processor to implement a method for detecting product tampering, the method comprising:
scanning, using a reader, for a signal from a communication device coupled to a seal on product packaging, the communication device having a memory, an electronic circuit and an antenna coupled to the electronic circuit, and the communication device coupled to the seal such that the antenna of the communication device is on a first portion of the seal and the electronic circuit of the communication device is on a second portion of the seal;
detecting tampering with the seal on the product packaging based on a lack of the signal to the reader from the communication device, wherein tampering with the seal causes the antenna to disconnect from the electronic circuit rendering the communication device to be unreadable by the reader; and
reading tampering data when tampering with the seal is detected, the tampering data being written to the memory of the communication device by the electronic circuit when the antenna is disconnected from the electronic circuit, the tampering data indicating at least a timestamp for when the antenna was disconnected from the electronic circuit.
